(19) United States
(12) Patent Application Publication
(10) Pub. No.: US 2019/0041034 A1
(43) Pub. Date: Feb. 7, 2019

(54) FILTER AND ILLUMINATING DEVICE

(71) Applicant: PANASONIC INTELLECTUAL PROPERTY MANAGEMENT CO., LTD., Osaka (JP)

(72) Inventors: Itaru ONISHI, Osaka (JP); Hideki WADA, Osaka (JP); Tomoya IWAHASHI, Osaka (JP)

(73) Assignee: PANASONIC INTELLECTUAL PROPERTY MANAGEMENT CO., LTD., Osaka (JP)

(21) Appl. No.: 16/051,923

(22) Filed: Aug. 1, 2018

(30) Foreign Application Priority Data
Aug. 4, 2017 (JP) 2017-151406

(51) Int. Cl. F21V 9/40; F21S 2/00; F21V 14/00; F21V 17/02

(52) U.S. Cl. CPC F21V 9/40; F21S 2/00; F21S 10/02; F21V 17/02; F21V 14/006

(57) ABSTRACT

A filter includes a first filter having a recess, and a second filter made of a material different from that of the first filter. The second filter has a housed portion to be housed in the recess of the first filter such that the second filter is removable relative to the first filter. The housed portion of the second filter may correspond to either the entirety or a portion of the second filter. This structure facilitates formation of the filter having a simple structure and implementation of desired light distribution of two or more different light beams.

### CROSS REFERENCE TO RELATED APPLICATION

The disclosure of Japanese Patent Application No. 2017-151406 filed on Aug. 4, 2017 including the specification, claims, drawings, and abstract is incorporated herein by reference in its entirety.

### TECHNICAL FIELD

This disclosure relates to filters, and to illuminating devices having the filter.

### BACKGROUND ART

A conventional illuminating device is disclosed, for example, in Japanese Unexamined Patent Application Publication No. 2012-234794. The illuminating device includes a plurality of LEDs, a projection unit for holding the LEDs such that each LED is held integrally with its corresponding lens, and an optical filter disposed on the projection surface side of the projection unit. The optical filter is a panel member with a shape substantially identical to that of the projection surface of the projection unit. The optical filter has filter areas defined discretely from one another on the front surface of the panel member. The illuminating device adjusts the filter areas to thereby adjust the color, amount, and diffusion condition of the illuminating light.

### SUMMARY

The above-mentioned illuminating device requires the filter areas to be positioned discretely from one another on the front surface of the panel member. This structure requires many steps to form the optical filter. Moreover, as two or more light beams having different wavelength distributions may be arranged so as to be distributed in respective desired directions according to specifications, it is preferable if such light distribution can be achieved with a simple structure.

In view of the above, an object of the present disclosure is to provide a filter and an illuminating device that can be readily made with a simple structure and that is capable of desired light distribution of two or more different light beams.

A filter according to this disclosure includes a first filter having at least one of a recess and a through hole, and a second filter made of a material different from that of the first filter, and having a housed portion to be housed in the recess or through hole of the first filter such that the second filter is removable relative to the first filter.

A filter and an illuminating device according to this disclosure has a readily made simple structure and can readily achieve desired distribution of two or more different light beams.

### BRIEF DESCRIPTION OF THE DRAWINGS

The figures depict one or more implementations in accordance with the present teaching, by way of example only, not by way of limitations. In the figures, like reference numerals refer to the same or similar elements.

FIG. 1 illustrates a schematic structure of an illuminating device according to a first embodiment of this disclosure;

FIG. 2A is a perspective view of the first filter of the above-mentioned illuminating device;

FIG. 2B is a perspective view of the second filter of the above-mentioned illuminating device;

FIG. 3 is a perspective view of the above-mentioned filters in an integrated state;

FIG. 4A is a plan view of the above-mentioned filters in an integrated state;

FIG. 4B is a side view of the above-mentioned filters in an integrated state;

FIG. 5 schematically illustrates an illuminated surface illuminated with the light from the lighting system;

FIG. 6 is a diagram to explain a preferable usage of the above-mentioned lighting system;

FIG. 7 is a diagram to explain another preferable usage of the above-mentioned lighting system;

FIG. 8 illustrates an image captured when one of the people at the table takes a picture of the other person and the food with a camera or a smartphone in the usage relevant to FIG. 7;

FIG. 9A is a perspective view of the first filter of a filter according to a second embodiment;

FIG. 9B is a perspective view of the second filter of a filter according to the second embodiment;

FIG. 9C is a perspective view of the third filter of a filter according to the second embodiment;

FIG. 10 is a perspective view of a filter according to the second embodiment with the first filter, the second filter, and the third filter in an integrated state;

FIG. 11A is a plan view of the filter according to the second embodiment in an integrated state;

FIG. 11B is a side view of the filter according to the second embodiment in an integrated state;

FIG. 12A is a perspective view of the first filter of a filter according to a third embodiment;

FIG. 12B is a perspective view of the second filter of the filter according to the third embodiment;

FIG. 13 is a perspective view of a filter according to the third embodiment in an integrated state;

FIG. 14A is a plan view of the filter according to the third embodiment in an integrated state;

FIG. 14B is a side view of the filter according to the third embodiment in an integrated state;

FIG. 15A is a perspective view of the first filter of a filter according to a fourth embodiment;

FIG. 15B is a perspective view of the second filter of the filter according to the fourth embodiment;

FIG. 16 is a perspective view of a filter according to the fourth embodiment in an integrated state;

FIG. 17A is a plan view of the filter according to the fourth embodiment in an integrated state;

FIG. 17B is a side view of the filter according to the fourth embodiment in an integrated state;

FIG. 18A is a plan view of a filter according to a modified example in an integrated state;

FIG. 18B is a plan view of a filter according to another modified example in an integrated state; and

FIG. 18C is a plan view of a filter according to still another modified example in an integrated state.

### DETAILED DESCRIPTION

The following describes the embodiments of this disclosure in detail with reference to the accompanying drawings. When two or more embodiments and/or modified examples are included, it is anticipated that any characteristic features of the embodiments and/or examples are desirably combined to create a new embodiment. In the following description, a front side or a lower side refers to a side from which light is emitted, while a rear side or an upper side refers to a side opposite from the side from which light is emitted. The drawings may include a schematic view. The ratios between length, width, and height of the respective members may not be constant among the respective drawings. In this specification, a truncated conical inner circumferential surface refers to an inner circumferential surface having a truncated conical shape, and a truncated conical outer circumferential surface refers to an outer circumferential surface having a truncated conical shape.

### First Embodiment

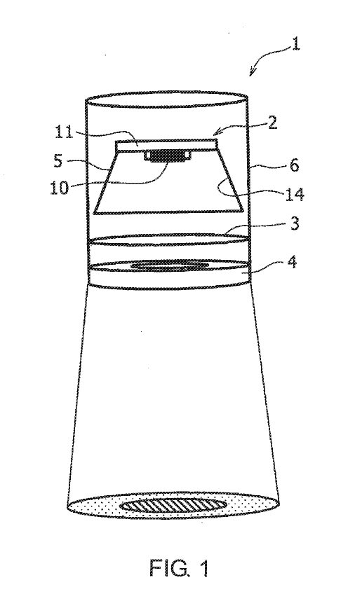

FIG. 1 illustrates a schematic structure of an illuminating device 1 according to a first embodiment of this disclosure. As illustrated in FIG. 1, the illuminating device 1 has a substantially cylindrical enclosure 6. The illuminating device 1 further has an LED board 2, a lens 3, a filter 4, and a reflection member 5 all included in the enclosure 6. The LED board 2 is fixed to the enclosure 6 or a component that is stationary relative to the enclosure 6. The LED board 2 includes a light source 10 and a substrate 11. The light source 10 includes, for example, a plurality of light emitting diodes (LED) mounted on the substrate 11 so as to be discrete from one another. The illuminating device 1 further includes a power unit (not illustrated) outside the enclosure 6. The power unit incorporates a conversion circuit mounted on a power substrate, which converts an AC power received into a DC power. With the DC power supplied from the power unit to the LED board 2, the LEDs are lit so that light is emitted from the light source 10.

The reflection member 5 has, for example, a truncated conical inner circumferential surface 14 that is more widely open toward the bottom and mounted on the substrate 11 so as to surround the light source 10. It is preferable that the central axis of the truncated conical inner circumferential surface 14 of the reflection member 5 is coaxial with the optical axis of the light emitted from the light source 10. The truncated conical inner circumferential surface 14 may have a metal layer that is formed on the front surface thereof, for example, through deposition, plating, or sputtering. Alternatively, a white coating film containing a white pigment may be formed. Still alternatively, the truncated conical inner circumferential surface 14 may have a mirror finished surface implemented through grinding, for example.

The lens 3 is disposed below and spaced apart from the reflection member 5. Specifically, the lens 3 is mounted inside the enclosure 6 so as to be substantially parallel to the substrate 11. The truncated conical inner circumferential surface 14 of the reflection member 5 reflects a part of the light from the light source 10 such that the light from the light source 10 efficiently goes into the upper surface of the lens 3.

The filter 4 is disposed below and spaced apart from the lens 3. The filter 4 has a substantially disk-like shape. The filter 4 is mounted inside the enclosure 6 so as to be substantially parallel to the substrate 11. The lens 3 condenses the light incident to the upper surface of the lens 3 to lead to the upper surface of the filter 4. The light having passed through the filter 4 is condensed, for example, into a spotlight beam to illuminate a local area. The lower portion of the enclosure 6 may be made of soft elastic material, such as silicon rubber. Soft elastic material has a light transmissive nature and diffuses light. Accordingly, the enclosure 6 having a lower portion made of soft elastic material enables brightening of the illuminating device 1 and therearound.

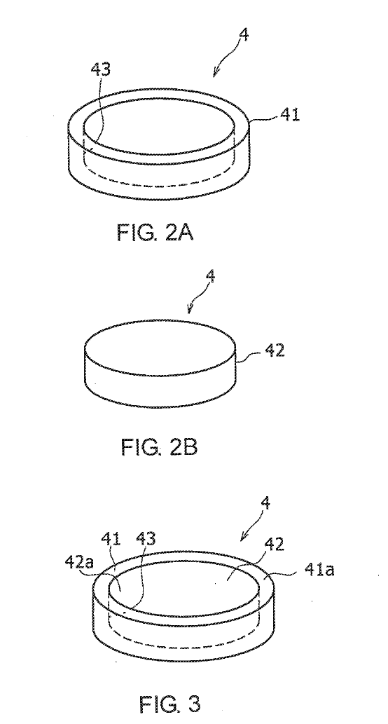

The filter 4 includes a first filter 41 and a second filter 42. FIG. 2A is a perspective view of the first filter 41 of the filter 4; FIG. 2B is a perspective view of the second filter 42 of the filter 4. The first filter 41 and the second filter 42 are made of mutually different materials. In detail, the first filter 41 and the second filter 42 contain the same kind of colorant at respective different content ratios.

The first filter 41 and the second filter 42 are made by blending coloring agent into natural pellets (particulate plastic before blending with colorant) and molding the blended material. The coloring agent has various kinds, including “masterbatch,” “colored pellet, colored compound,” “dry color,” and “paste color, liquid color.”

Masterbatch is a pelletal (particulate) coloring agent and contains high-density pigment. Color gradation can be readily expressed with masterbatch by adjusting the amount of pigment to be blended into natural pellet. Masterbatch is superior in dispersibility and exhibits uniform and clear color. Masterbatch allows easy handling with no worry about scattering and staining devices. Masterbatch is superior in cost performance, as compared with colored pellet.

Colored pellet and colored compound are pelletal coloring agents. Different from masterbatch, colored pellet and colored compound are adjusted so as to have the same color density (tint) as that of a finished product, thus not requiring blending with natural pellet. Colored pellet and colored compound save the trouble of blending, and easily and stably exhibit a desired color.

Dry color is a powdery coloring agent. Dry color is produced, for example, by blending pigment and metal soap. Dry color requires little labor in production and thus is the most inexpensive coloring agent.

Paste color and liquid color are liquid coloring agents. Paste color differs in viscosity from liquid color. Paste color is used mainly with liquid base resin, such as vinyl chloride. Liquid color is preferably used when slight coloring, such as translucent coloring, of a product is desired.

Plastic for blending with coloring agent includes thermo plastic (thermally melted and molded). Thermo plastic can be classified into “crystalline” and “amorphous” plastics. Crystalline plastic includes polyethylene (PE) and polyethylene terephthalate (PET). A method for molding a filter includes, for example, compression molding, injection molding, calendar molding, extrusion molding, blow molding, and vacuum forming. Injection molding enables easy and inexpensive production of filters, using a die.

As illustrated in FIG. 2A, the first filter 41 includes a disk-like member having a disk-like recess 43 that is open on the rear surface of the first filter 41. The central axis of the first filter 41 substantially coincides with that of the recess 43. As illustrated in FIG. 2B, the second filter 42 has a disk-like shape substantially coincident with that of the recess 43. The second filter 42 can fit inside the recess 43.

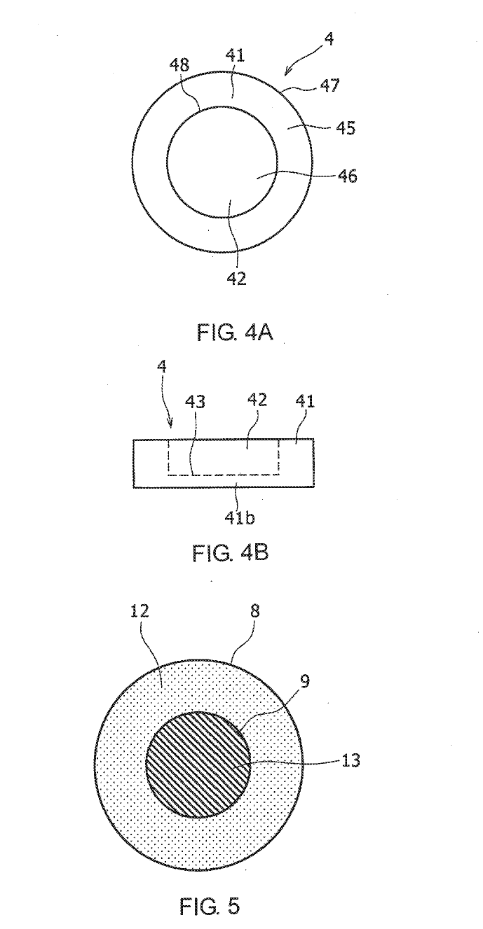

FIG. 3 is a perspective view of the filter 4 with the second filter 42 tightly fit inside the recess 43 of the first filter 41 such that the first filter 41 is integrated with the second filter 42, or in an integrated state. FIG. 4A is a plan view of the filter 4 in the integrated state. FIG. 4B is a side view of the filter 4 in the integrated state.

As illustrated in FIG. 3, the second filter 42 is fully housed inside the recess 43 of the first filter 41 in the integrated state. In the integrated state, the rear surface 41a of the first filter 41 is flush with the rear surface 42a of the second filter 42. The first filter 41 and the second filter 42 together constitute a disk-like member. In the first embodiment, the entire second filter 42 constitutes a housed portion to be tightly housed inside the recess 43.

As illustrated in FIG. 4A, the upper surface of the filter 4 in the integrated state includes two areas; namely, first and second areas 45, 46, defined by co-axial circles. The first area 45 is a partial area of the first filter 41. The first area 45 is present between a large circle 47, and a small circle 48 that is smaller in diameter than the large circle 47. The second area 46 is a partial area of the second filter 42. The second area 46 includes an area encircled by the small circle 48.

As illustrated in FIG. 4B, the first filter 41 has an overlap area 41b that overlaps the second filter 42 with the filter 4 in the integrated state, when viewed from the thickness direction (that is, the axial direction). The overlap area 41b constitutes the bottom of the recess 43 of the first filter 41. FIGS. 4A and 4B are referred to here. The light incident to the first area 45 of the upper surface of the filter 4 in the integrated state passes through only the first filter 41 before emerging on the lower side. Meanwhile, the light incident to the second area 46 of the upper surface of the filter 4 in the integrated state passes through the second filter 42 and the first filter 41 sequentially before emerging on the lower side. As a result, the light incident to the first area 45 and the light incident to the second area 46 proceed downward as mutually different light beams.

FIG. 5 schematically illustrates an illuminated surface illuminated with the light from the illuminating device 1. In the first embodiment, because of the shape of the filter 4, two co-axial circles; namely, a large circle 8, and a small circle 9 that is smaller in diameter than the large circle 8, appear on the illuminated surface. A first area 12 between the large circle 8 and the small circle 9 and a second area 13 encircled by the small circle 9 are illuminated with light in mutually different colors, respectively. The first area 12 is illuminated with the light having passed through only the first filter 41. The second area 13 is illuminated with the light having passed through the second filter 42 and the first filter 41.

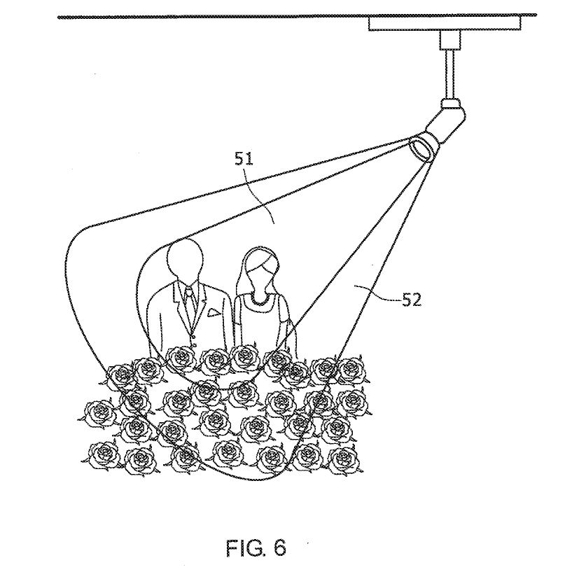

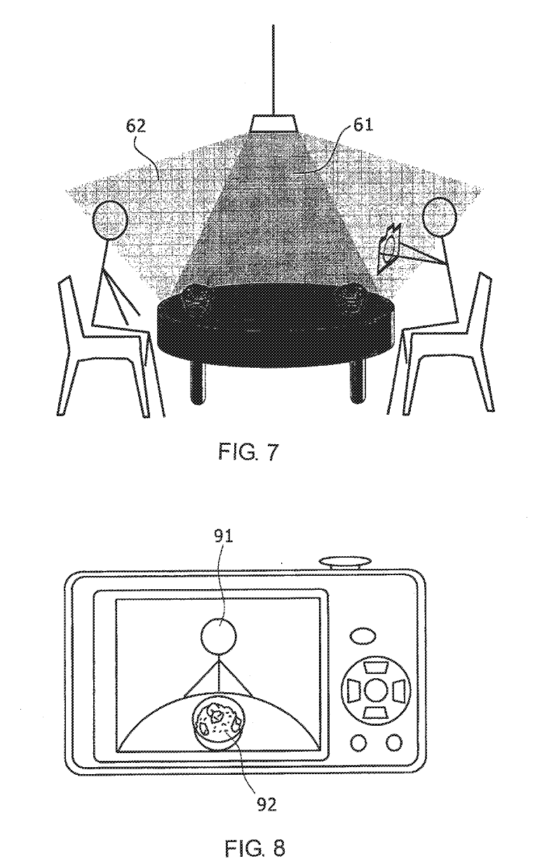

FIGS. 6 and 7 are diagrams to explain examples of preferable usages of the illuminating device 1. Specifically, FIG. 6 explains use of the illuminating device 1 as a spotlight in a wedding; FIG. 7 explains use of the illuminating device 1 to illuminate a dining table.

Referring to FIG. 6, use of the illuminating device 1 as a spotlight in a wedding will be described. In this case, the middle portion of the illuminating light, or the light 51, illuminates the bride and bridegroom. This light 51 includes light in Bikoshoku (beautiful light color). Meanwhile, a peripheral portion of the illuminating light, or the light 52, illuminates flowers, such as bouquets, that decorate the stage. This light 52 includes light in Saikoshoku (bright light color). That is, the LED and the first and second filters 41, 42 are adjusted such that the light 51 having been emitted from the light source 10 and passed through the first filter 41 and the second filter 42 makes light in Bikoshoku. Further, the LED and the first filter 41 are adjusted such that the light 52 having been emitted from the light source 10 and passed through only the first filter 41 makes light in Saikoshoku.

Note here that light in Bikoshoku is light whose spectral power of the optical components at wavelengths from 570 to 580 nm is lower as compared with that of the light from a typical white LED. The PS of the light in Bikoshoku is as high as about 95, the Ra is as high as about 95, and the FCI is as high as about 115. Note that PS stands for Preference Index of Skin Color, or an index developed by Panasonic Corporation through a search for and to quantify “skin color considered beautiful by Japanese women” (Japanese Unexamined Patent Application Publication No. Hei 8-55610). The PS is a numerical index indicating closeness of an actual skin color to the ideal skin color. A higher PS indicates a skin color closer to the ideal skin color.

Ra stands for an average color rendering index. The Ra is a representative index to quantify color faithfulness and indicates how faithful a reproduced color is to the color of a standard light source (JIS (Z-8726: 1990)). The closer to 100 the Ra is, the more naturally the color appears. FCI stands for Feeling of Contrast Index. The FCI is an index developed by Panasonic Corporation through a search for and to quantify an effect of making colors appear vivid and outstanding (Japanese Unexamined Patent Application Publication No. Hei 9-120797).

Light in Saikoshoku has higher saturation as a result of adjustment of the optical components at wavelengths of around 580 nm to suppress yellow. The peak wavelength of red components of the light in Saikoshoku is shifted toward the longer wavelength side so that a strongly reddish color can be expressed more vividly. The light in Saikoshoku can emphasize clearness and vividness of vegetables and luster of fresh fish. This light enables more attractive presentation of products. Further, the light in Saikoshoku can emphasize red tint of food, such as red flesh of meat or raw fish, and white tint of white flesh. That is, the light in Saikoshoku enables presentation of food in such a manner that the food appears more fresh and delicious. Still further, the light in Saikoshoku has warmth. The light can make bread and cooked food appear as if they had been just baked and cooked, respectively.

In the example illustrated in FIG. 6, the bride can be illuminated with light in Bikoshoku, and the flowers on the stage can be illuminated with light in Saikoshoku. This can produce an effect of having the bride appear more beautiful and the flowers on the stage appear more vivid and fresh. Below, referring to FIG. 7, use of the illuminating device 1 to illuminate a dining table will be described. In this case, for example, the LED and the first and second filters 41, 42 are adjusted such that light 61 having been emitted from the light source 10 and passed through the second filter 42 and the first filter 41 makes light with high color rendering nature, while the LED and the first filter 41 are adjusted such that light 62 having been emitted from the first filter 41 and passed through only the first filter 41 makes light in Bikoshoku. With this adjustment, an effect of having the food on the table appear delicious and the people at the table appear more natural is achieved. For example, assume that one of the people at the table takes a picture, as is illustrated in FIG. 8, of the other person or the food on the table with a camera or a smartphone. In this case, the picture obtained shows the person 91 appearing naturally and the food 92 appearing delicious. As illustrated in these examples, it is preferable that an area illuminated with the light from the illuminating device includes a first area, and a second area around the first area; that the first area is illuminated with first light with the average color rendering index Ra at 94.5 or greater; and that the second area is illuminated with second light different from the first light.

According to the first embodiment, the filter 4 includes the first filter 41 having the recess 43. The filter 4 additionally includes the second filter 42 that is made of a material different from that of the first filter 41 and has a housed portion to be housed inside the recess 43 of the first filter 41 such that the second filter 42 is removable relative to the first filter 41.

Accordingly, the filter 4 can be formed including only the first and second filters 41, 42. The first and second filters 41, 42 can be readily formed, for example, through injection molding. That is, the filter 4 can be formed more easily, as compared with a structure including filter areas defined discrete from one another on the front surface of a panel member.

The recess 43 or a through hole formed on the first filter 41 is desirably adjustable according to specifications. The housed portion of the second filter 42 to be housed in the recess 43 or the through hole of the first filter 41 as well is readily and desirably adjustable according to specifications. Accordingly, it is possible to readily achieve desired distribution of two or more different light beams with a simple structure.

The first filter 41 and the second filter 42 may contain the same kind of colorant. The content ratio of the colorant of the first filter 41 may differ from that of the second filter 42.

The above-described structure can make smaller the difference in optical spectrum between the first light having passed through the first filter 41 and the second light having passed through the second filter 42. This makes less outstanding the boundary between the first light and the second light, so that light without unnaturalness can be produced.

The illuminating device 1, which has the filter 4, may additionally have the light source 10 and the lens 3 so that the light from the light source 10 at least partially passes through the lens 3 and then enters the filter 4. This structure can efficiently lead the light from the light source 10 to the upper surface of the filter 4. Accordingly, it is possible to emit light with high brightness.

The first filter 41 has the recess 43 having a bottom portion. This structure can hold the second filter 42 inside the recess 43 of the first filter 41 to prevent the second filter 42 from dropping from the first filter 41.

The above has described a case, as illustrated in FIG. 3, in which the upper surface (the rear surface 41a) of the first filter 41 is flush with the upper surface (the rear surface 42a) of the second filter 42 in the integrated state. Alternatively, the upper surface of the first filter may not be flush with the upper surface of the second filter in the integrated state. That is, the respective upper surfaces may be positioned at different levels. In detail, the whole second filter may be tightly housed in a lower portion of the recess of the first filter such that the rear surface of the second filter is positioned at a level lower than that of the rear surface of the first filter. Still alternatively, a part of the second filter may be tightly housed in the recess of the first filter such that the rear surface of the second filter is positioned at a level higher than that of the rear surface of the first filter.

The above has described a case in which the filter 4 is used with the first filter 41 and the second filter 42 in an integrated state. Alternatively, the filter 4 may be used with the second filter 42 removed from the first filter 41. That is, the filter 4 may include only the first filter 41 and be used only with the first filter 41.

### Second Embodiment

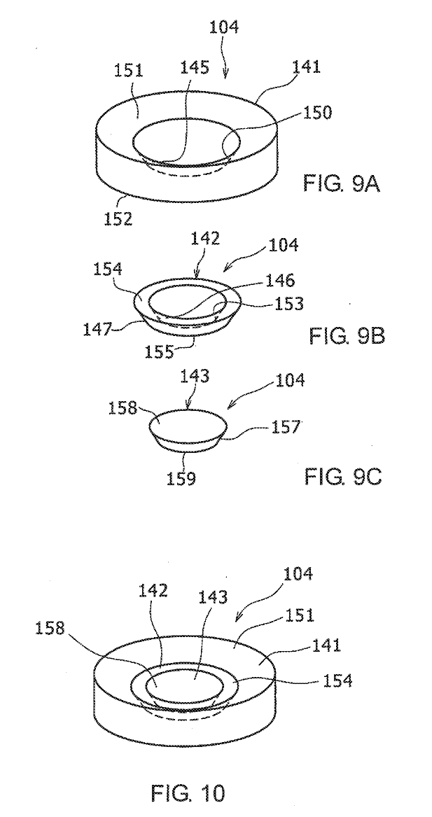

FIG. 9A is a perspective view of a first filter 141 of a filter 104 according to a second embodiment. FIG. 9B is a perspective view of a second filter 142 of the filter 104. FIG. 9C is a perspective view of a third filter 143 of the filter 104. The first filter 141, the second filter 142, and the third filter 143 are made of mutually different materials. In the second embodiment, an effect and a modified example similar to those of the first embodiment are not described.

As illustrated in FIG. 9A, the first filter 141 has a ring shape, or a disk-like shape with a through hole 145 at the center thereof. The through hole 145 has a truncated conical inner circumferential surface 150 having a truncated conical shape that becomes smaller in diameter toward the bottom. An upper surface 151 and a lower surface 152 of the first filter 141 are flat surfaces and parallel to each other. The central axis of the through hole 145 is parallel to the normal of the upper surface 151.

As illustrated in FIG. 9B, the second filter 142 is a ring member with a through hole 146 at the center thereof. The through hole 146 has a truncated conical inner circumferential surface 153 having a truncated conical shape that becomes smaller in diameter toward the bottom. The outer circumferential surface of the second filter 142 is a truncated conical outer circumferential surface 147 having a truncated conical shape that becomes smaller in diameter toward the bottom. The shape of the truncated conical outer circumferential surface 147 is substantially coincident with that of the truncated conical inner circumferential surface 150 of the first filter 141. An upper surface 154 and a lower surface 155 of the second filter 142 are flat surfaces and parallel to each other. The central axis of the through hole 146 is parallel to the normal of the upper surface 151.

As illustrated in FIG. 9C, the third filter 143 has a shape substantially coincident with that of the through hole 146 of the second filter 142. The outer circumferential surface of the third filter 143 is a truncated conical outer circumferential surface 157 having a truncated conical shape that becomes smaller in diameter toward the bottom. An upper surface 158 and a lower surface 159 of the third filter 143 are flat surfaces and parallel to each other. The central axis of the truncated conical outer circumferential surface 157 is parallel to the normal of the upper surface 158.

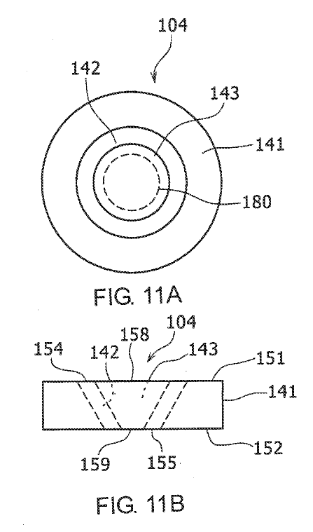

FIG. 10 is a perspective view of the filter 104 with the first filter 141, the second filter 142, and the third filter 143 in an integrated state. FIG. 11A is a plan view (a top view) of the filter 104 in the integrated state. FIG. 11B is a side view of the filter 104 in the integrated state. A dotted line 180 in FIG. 11A indicates the edge of the lower surface of the third filter 143. As illustrated in FIG. 11B, the first filter 141, the second filter 142, and the third filter 143 all have the same height. As illustrated in FIGS. 10 and 11B, the filter 104 in the integrated state has a disk-like shape in which the upper surface (the rear surface) 151 of the first filter 141, the upper surface (the rear surface) 154 of the second filter 142, and the upper surface (the rear surface) 158 of the third filter 143 are substantially flush with one another. In the integrated state, the lower surface (the front surface) 152 of the first filter 141, the lower surface (the front surface) 155 of the second filter 142, and the lower surface (the front surface) 159 of the third filter 143 are substantially flush with one another.

Similar to the second embodiment, the first filter 141 may have a ring shape.

The above-described structure can readily and appropriately form different types of light for a portion of the light to be emitted from the illuminating device to illuminate a middle portion of an illuminated area and for a peripheral portion of the light to illuminate a peripheral portion of the illuminated area, respectively, based on specifications.

The second filter 142 may have the central axis. The second filter 142 may be at least partially housed in the through hole 145 of the first filter 141. Each of the front surface (the lower surface 155) of the second filter 142 on one side of the second filter 142 in its thickness direction (the axial direction) and the rear surface (the upper surface 154) of the second filter 142 on the other side in its thickness direction may have a round shape. The diameter of the lower surface 155 may differ from that of the upper surface 154.

The above-described structure allows the lower surface 155 of the second filter 142 to be housed in the through hole 145 of the first filter 141 to have a smaller diameter than that of the upper surface 154. This structure can prevent the second filter 142 from dropping from the first filter 141 when the first filter 141 is formed having the through hole 145 instead of a recess having a bottom portion. Accordingly, this structure can produce light beams passing through only the respective filters 141, 142, 143, different from the first embodiment. That is, two or more (three in the second embodiment) different light beams can be readily produced.

The through hole 145 of the first filter 141 may have a truncated conical inner circumferential surface 150 having a truncated conical shape that becomes smaller in diameter toward the front side of the filter 104. The truncated conical outer circumferential surface 147 may be substantially coincident with at least a part of the truncated conical inner circumferential surface of the through hole 145. The second filter 142 may have a through hole 146 having the truncated conical inner circumferential surface 153 having a truncated conical shape that becomes smaller in diameter toward the front side of the filter 104. The filter 104 may additionally have the third filter 143 having a shape substantially coincident with the truncated conical shape defined by at least a part of the through hole 146 of the second filter 142. Either the third filter 143, or both the second filter 142 and the third filter 143 may be removable.

The above-described structure can form illuminating light composed of three mutually different types of light. Further, the above-described structure can easily and inexpensively form a structure that prevents the second and third filters 142, 143 from dropping from the first filter 141. The second filter 142 can be held on the smooth surface of the first filter 141. The third filter 143 can be held on the smooth surface of the second filter 142. Accordingly, it is possible to readily define the boundaries between the respective light portions of the illuminating light, which pass through the respective filters 141, 142, 143, as smooth closed curved lines. With the above, an object can be illuminated beautifully with the illuminating light.

Two or more of the first, second, and third filters may have different heights. In detail, it is sufficient that at least a part of the truncated cone inner circumferential surface of the first filter abuts on at least a part of the truncated cone outer circumferential surface of the second filter, and that at least a part of the truncated cone inner circumferential surface of the second filter abuts on at least a part of the truncated cone outer circumferential surface of the third filter. Further, two or more of the rear surfaces of the first, second, and third filters may have different heights, and two or more of the front surfaces of the first, second, and third filters may have different heights. Although a case in which three filters 141, 142, 143 are integrated with one another via truncated cone surfaces has been described, two filters may be integrated with each other via a truncated cone surface, or four or more filters may be integrated with one another via truncated cone surfaces.

The filter 104 may be used with only the third filter 143 removed from the first filter 141. Alternatively, the filter 104 may be used with both the second and third filters 142, 143 removed from the first filter 141. In these uses, the removal results in a through hole at the center of the first filter 141. Accordingly, a part of the light from the illuminating device proceeds directly; that is, does not pass through a filter, downward. Such a filter 104 may be used, for example, with an LED that emits light in Bikoshoku. That is, a middle portion of the light from the LED proceeds downward intact, or without passing through a filter, while a peripheral portion of the light passes through the third filter to be thereby converted into light in Saikoshoku before proceeding downward.

### Third Embodiment

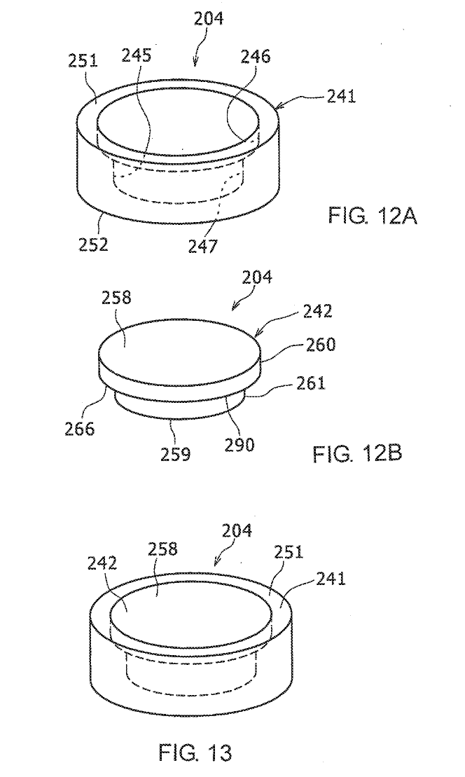

FIG. 12A is a perspective view of a first filter 241 of a filter 204 according to a third embodiment. FIG. 12B is a perspective view of a second filter 242 of the filter 204. The first filter 241 and the second filter 242 are made of mutually different materials. In the third embodiment, an effect and a modified example similar to those of the first and second embodiments are not described.

As illustrated in FIG. 12A, the first filter 241 has a disk-like shape with a through hole 245 at the center thereof. The through hole 245 includes a large cylindrical hole 246, and a small cylindrical hole 247 that is smaller in diameter than the large cylindrical hole 246. The large cylindrical hole 246 is co-axial with the small cylindrical hole 247. An upper surface 251 and a lower surface 252 of the first filter 241 are flat surfaces and parallel to each other. The central axis of the through hole 245 is parallel to the normal of the upper surface 251.

As illustrated in FIG. 12B, the second filter 242 has a shape substantially coincident with that of the through hole 245 of the first filter 241. The second filter 242 includes a large disk portion 260, and a small disk portion 261 that is smaller in diameter than the large disk portion 260. The large disk portion 260 is coaxial with the small disk portion 261. An upper surface 258 and a lower surface 259 of the second filter 242 are flat surfaces and parallel to each other. The central axis of the large disk portion 260 is parallel to the normal of the upper surface 258. The large disk portion 260 is connected to the small disk portion 261 via a step portion 266. A lower surface 290 of the step portion 266 is parallel to the upper surface 258.

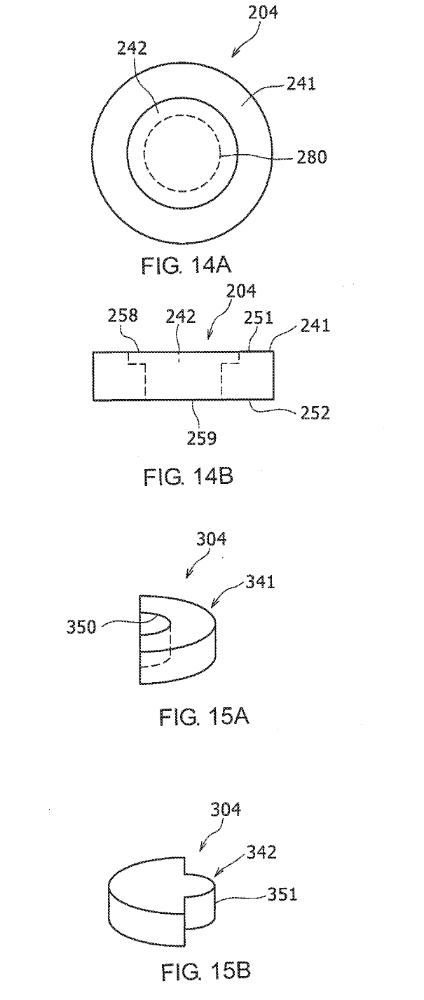

FIG. 13 is a perspective view of the filter 204 with the first filter 241 and the second filter 242 in an integrated state. FIG. 14A is a plan view (a top view) of the filter 204 in the integrated state. FIG. 14B is a side view of the filter 204 in the integrated state. A dotted line 280 in FIG. 14A indicates the edge of the lower surface of the second filter 242. As illustrated in FIG. 14B, the first filter 241 and the second filter 242 have the same height. As illustrated in FIGS. 13, 14B, the filter 204 in the integrated state has a disk-like shape in which the upper surface 251 of the first filter 241 is substantially flush with the upper surface 258 of the second filter 242. In the integrated state, the lower surface 252 of the first filter 241 is substantially flush with the lower surface 259 of the second filter 242. Alternatively, the upper surface of the first filter may not be flush with the upper surface of the second filter in the integrated state. The lower surface of the first filter may not be flush with the lower surface of the second filter in the integrated state.

As described above in the third embodiment, in the through hole 245 of the first filter 241 the large cylindrical hole 246 that is larger in diameter than the small cylindrical hole 247 may be positioned closer to the rear surface of the filter 204 than the small cylindrical hole 247 is. The second filter 242 may have a shape substantially coincident with at least a part of the through hole 245 of the first filter 241. The second filter 242 may include a smaller cylindrical outer circumferential surface, and a larger cylindrical outer circumferential surface that is larger in diameter than the smaller cylindrical outer circumferential surface.

The above-described structure prevents the large disk portion 260 of the second filter 242 from passing through the small cylindrical hole 247 of the through hole 245 of the first filter 241. Thus, similar to the second embodiment, the third embodiment can prevent the second filter 242 from dropping from the first filter 241.

### Fourth Embodiment

FIG. 15A is a perspective view of a first filter 341 of a filter 304 according to a fourth embodiment. FIG. 15B is a perspective view of a second filter 342 of the filter 304. The first filter 341 and the second filter 342 are made of mutually different materials. In the fourth embodiment, an effect and a modified example similar to those of the first to third embodiments are not described.

As illustrated in FIG. 15A, the first filter 341 has a structure formed by vertically halving a disk member such that the upper surface of the member has a semicircular shape. The halved disk-like member has a semi-cylindrical recess 350 formed at the center of its flat surfaces in its width direction and extending in its thickness direction. As illustrated in FIG. 15B, the second filter 342 includes a vertically halved disk member, such as is described above, having a land portion 351 formed at the center of its flat surfaces in the width direction and extending in its thickness direction.

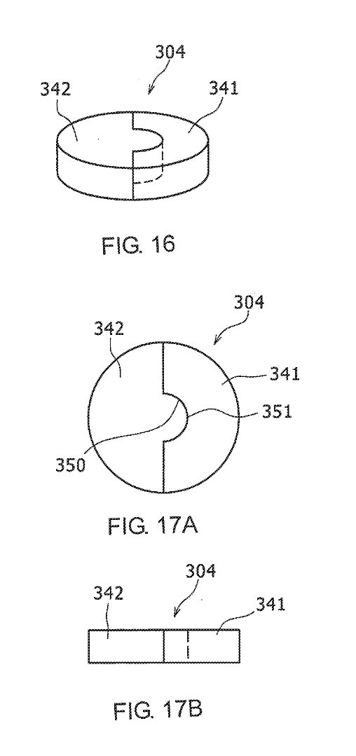

FIG. 16 is a perspective view of the filter 304 with the first filter 341 and the second filter 342 in an integrated state. FIG. 17A is a plan view (a top view) of the filter 304 in the integrated state. FIG. 17B is a side view of the filter 304 in the integrated state. As illustrated in FIGS. 16, 17A, 17B, the land portion 351 of the second filter 342 has a shape coincident with that of the recess 350 of the first filter 341. The filter 304 in the integrated state has a disk-like shape. Alternatively, the filter in the integrated state may not have a disk-like shape. The upper surface of the first filter may not be flush with that of the second filter in the integrated state. The lower surface of the first filter may not be flush with that of the second filter in the integrated state.

As described above in the fourth embodiment, it may be the case that both of the first and second filters 341, 342 have a ring structure. In the fourth embodiment, the housed portion of the second filter 342 corresponds to the semi-cylindrical land portion 351, rather than the entire second filter 342. The filter 304 in the fourth embodiment requires the first and second respective filters 341, 342 in the integrated state to be respectively fixed to a stationary portion, such as the enclosure.

Note that this disclosure is not limited to the above-described first to fourth embodiments and modified examples thereof. Various improvements and modifications of the characteristic features defined in the claims of this application and within a range equivalent to the characteristic features are possible.

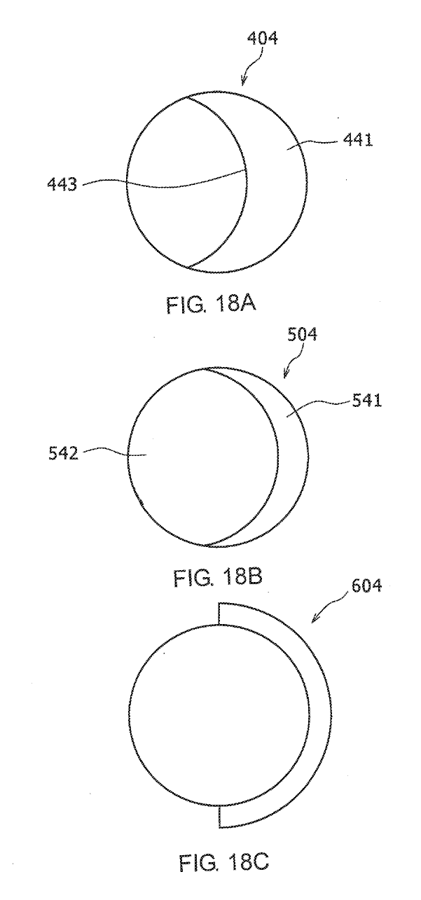

For example, as illustrated in FIG. 18A; that is, in a plan view (a top view) of a filter 404 according to a modified example in the integrated state, the filter 404 in the integrated state may have a disk-like shape. A recess 443 of a first filter 441 may have an arc bottom surface. As illustrated in FIG. 18B, or a plan view (a top view) of a filter 504 in the integrated state according to another modified example, the filter 504 in the integrated state may have a disk-like shape. As illustrated in FIGS. 18A, 18B, in a plan view of the upper surface of the filter 504 in the integrated state, the ratio in area of a crescent first filter 541 relative to the upper surface of the filter 504 may be desirably adjusted depending on use. The volume of the first filter 541 may be smaller than that of a second filter 542 or vice versa. As illustrated in FIG. 18C, or in a plan view (a top view) of a filter 604 in the integrated state according to a still modified example, a plan view of the filter 604 in the integrated state may not exhibit a round shape.

Although a first filter having only either one of a recess and a through hole has been described in the above, the first filter may have two or more through holes and no recess. Alternatively, the first filter may have two or more recesses and no through hole. Still alternatively, the first filter may have one or more recesses and one or more through holes. In other words, the structure of the first filter can be desirably modified according to specifications.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. A filter comprising:
a first filter having at least either one of a recess and a through hole; and
a second filter made of a material different from a material of the first filter and having a housed portion to be housed in the recess or the through hole of the first filter such that the second filter is removable relative to the first filter.

2. The filter according to claim 1, wherein
the first filter and the second filter contain the same kind of colorant, and
a content ratio of the colorant of the first filter differs from a content ratio of the colorant of the second filter.

3. The filter according to claim 1, wherein the first filter has a ring shape.

4. The filter according to claim 3, wherein
the second filter has a central axis,
the second filter is at least partially housed in the through hole of the first filter,
each of a front surface of the second filter on one side of the second filter in an axial direction of the second filter and a rear surface of the second filter on another side of the second filter in the axial direction has a round shape, and
the front surface has a diameter different from a diameter of the rear surface.

5. The filter according to claim 3, wherein
the through hole of the first filter has a truncated conical inner circumferential surface having a truncated conical shape that becomes smaller in diameter toward a front side of the filter,
the second filter has a truncated conical outer circumferential surface that is substantially coincident with at least a part of the truncated conical inner circumference of the through hole and a through hole having a truncated conical inner circumferential surface having a truncated conical shape that becomes smaller in dimension toward the front side of the filter,
the filter further comprises a third filter having a shape substantially coincident with a truncated conical shape constituted by at least a part of the through hole of the second filter, and
either the third filter, or both the second filter and the third filter is/are removable.

6. The filter according to claim 4, wherein
the through hole of the first filter includes a small cylindrical hole, and a large cylindrical hole that is larger in diameter than the small cylindrical hole and positioned closer to a rear side of the filter than the small cylindrical hole is, and
the second filter has a shape substantially coincident with a shape of at least a part of the through hole of the first filter and includes a small cylindrical outer circumferential surface, and a large cylindrical outer circumferential surface that is larger in diameter than the small cylindrical outer circumferential surface.

7. An illuminating device comprising the filter according to claim 1.

8. The illuminating device according to claim 7, wherein
an area illuminated with light from the illuminating device includes a first area, and a second area surrounding the second area,
the first area is illuminated with first light whose average color rending index Ra is 94.5 or greater, and
the second area is illuminated with second light different from the first light.

9. The illuminating device according to claim 7, comprising:
a light source, and
a lens,
wherein
at least a part of light from the light source passes through the lens and then enters the filter.
